(19) United States
(12) Patent Application Publication
(10) Pub. No.: US 2014/0279491 A1
(43) Pub. Date: Sep. 18, 2014

(54) METHOD AND APPARATUS FOR VEHICLE ACCESSIBLE ATM TRANSACTIONS

(71) Applicant: FORD GLOBAL TECHNOLOGIES, LLC, Dearborn, MI (US)

(72) Inventors: DOUGLAS RAYMOND MARTIN, Canton, MI (US); KENNETH JAMES MILLER, Canton, MI (US)

(73) Assignee: FORD GLOBAL TECHNOLOGIES, LLC, Dearborn, MI (US)

(21) Appl. No.: 13/828,473

(22) Filed: Mar. 14, 2013

(51) Int. Cl. G06Q 20/10

(52) U.S. Cl. CPC G06Q 20/1085
USPC 705/43

(57) ABSTRACT

A system includes an ATM-related processor configured to detect a vehicle approach. The processor is also configured to wirelessly connect to a vehicle computing system (VCS). The processor is additionally configured to validate a vehicle as a present-vehicle. Also, the processor is configured to receive account and vehicle identifying information. The processor is also configured to validate an account as authorized for a transaction in conjunction with the vehicle. The processor is further configured to provide transaction services to the vehicle over the wireless connection, such that the user can interact with an ATM through use of an in-vehicle display.

### TECHNICAL FIELD

The illustrative embodiments generally relate to a method and apparatus for vehicle accessible ATM transactions.

### BACKGROUND

Advancing vehicular computing to further improve the driving experience has long been a goal of the automotive industry. Integrated systems provide for hands-free calling, on-demand media delivery, streaming audio service integration and a wealth of navigation and other features.

There are, however, always opportunities for expansion. Vehicle systems are not commonly integrated with the world surrounding the vehicle. In several examples, attempts have been made to facilitate extra-vehicular system access within the vehicle.

U.S. Application Publication No. 2010/0114734 generally describes a method for making a purchase using a vehicle computing system including receiving input to the vehicle computing system instructing order initiation. The method also includes receiving a selection at the vehicle computing system of a merchant from which to order. The method further includes receiving an order at the vehicle computing system, determining an address of the merchant to which the order was placed and providing directions to the address. These can be provided as, for example, turn by turn directions spoken and/or displayed on a navigation display. Finally, the exemplary method includes processing a payment for the order.

U.S. Ser. No. 13/429,707 generally relates to a computer implemented method including receiving a request for payment-related information at a wireless device. The method also includes communicating between the wireless device and a paired vehicle computing system (VCS) to verify the presence of a known vehicle. Further, the method includes transmitting requested payment-related information, responsive to the verification of the presence of the known vehicle.

### SUMMARY

In a first illustrative embodiment, a system includes an ATM-related processor configured to detect a vehicle approach. The processor is also configured to wirelessly connect to a vehicle computing system (VCS). The processor is additionally configured to validate a vehicle as a present-vehicle. Also, the processor is configured to receive account and vehicle identifying information. The processor is also configured to validate an account as authorized for a transaction in conjunction with the vehicle. The processor is further configured to provide transaction services to the vehicle over the wireless connection, such that the user can interact with an ATM through use of an in-vehicle display.

In a second illustrative embodiment, a system includes a processor configured to receive a request for identifying information from an ATM. The processor is also configured to provide account and vehicle identifying information responsive to the request. The processor is additionally configured to receive confirmation that the account is authorized for a transaction in conjunction with the vehicle. The processor is further configured to receive a list of ATM-related services. Also, the processor is configured to present the services on a vehicle display for user interaction and selection and transmit user requests input on the display to the ATM for servicing.

In a third illustrative embodiment, a computer-implemented method includes receiving a request for identifying information from an ATM. The method also includes providing account and vehicle identifying information responsive to the request. The method further includes receiving confirmation that the account is authorized for a transaction in conjunction with the vehicle. Additionally, the method includes receiving a list of ATM-related services. The method also includes presenting the services on a vehicle display for user interaction and selection and transmitting user requests input on the display to the ATM for servicing.

### BRIEF DESCRIPTION OF THE DRAWINGS

FIG. 1 shows an illustrative vehicle computing system;

FIG. 2 shows an illustrative process for transaction processing;

FIGS. 3A and 3B show an illustrative validation process;

FIG. 4 shows an illustrative example of another transaction process; and

FIG. 5 shows an illustrative example of an account setup process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

While some forays have been made into the world of connecting a vehicle based payment system into remotely sourced payment computers (such as at a gas station or fast food restaurant), significant room for expansion in the area of extra-vehicular activity still exists.

The illustrative embodiments contemplate a situation whereby a driver can access an automated teller machine (ATM) from within a vehicle using a vehicle display. With sufficient security features in place, a user doesn't have to be exposed to the elements while processing a drive-through ATM transaction. Then, when the user is ready to obtain the money or deposit any deposits, the user can roll down the window, make the necessary physical transactions, roll up the window and drive away.

FIG. 2 shows an illustrative process for transaction processing. In this illustrative example, an ATM machine, or a sensor provided thereto, detects the approach of a vehicle 201. In this illustrative example, when the machine detects an approaching vehicle, the machine enters a search mode 203. This causes a wireless connection on the machine to search for possible connection candidates. Once a suitable candidate is found, the process will cause the machine to connect to the driver on a short-range network 205. Otherwise, the process continues until the connection is established.

Once a connection is established, the process may begin a security authorization function 209. Since multiple vehicles may be in line to use the same machine, it may be desirable to engage several security measures, to ensure that the vehicle next to the machine is also the vehicle for which a transaction is being processed. It may be the case that the short-range wireless link connects with multiple vehicles in line. If this is the case, identification of which vehicle for which to process the present transaction must be made. While it is possible to ask people if they are the next in line, it is more advisable to provide some form of secure validation.

Several possible validation concepts include: near-field communication or a brief interaction with the ATM. Other suitable means of identifying an appropriate vehicle amongst several may also be used. In the near-field model, RFID or other near-field wireless technology communicates with an NFC chip provided to the vehicle. This chip can contain a unique identifier which can identify the VIN or other characteristic of the vehicle (such as a unique ID number provided to the chip). When the account was created, this ID number would have been associated with the account, so if the user's remaining account information does not match, the machine would know that the vehicle for which the ID was obtained does not correspond to the accessing account.

This way, if several users are inputting account information at the same time, the machine can determine which vehicle's account information corresponds to the vehicle currently sitting beside the machine.

In the interaction model, a PIN is used for identification purposes. The user's vehicle will provide the necessary account information to the machine when the vehicle establishes communication with the ATM. The user can then use the ATM screen to input a PIN number. This PIN number can be compared to all accounts currently in communication with the ATM (which would typically be 5-6 accounts at most). If the PIN matches an account, and only one account, the system can assume that this is the correct account for the vehicle present at the ATM. If the PIN matches multiple accounts, the user may be instructed to insert the card and forced to process the transaction in the standard fashion, since it may not be possible to otherwise determine the user identity. Since the PIN is physically input into the ATM, the user in front of the ATM is the user corresponding to the PIN, and also to the related account.

Regardless of the security mode used, the process will determine if the user can be authenticated 211 for continuing with the transaction. If the user has attempted authentication for a maximum number of tries 213, the process may exit. If the user is successfully authenticated before the system times out, the process begins to handle the transaction 215.

Once the vehicle has been authenticated, the process will pass information to a vehicle display, so that the user can interact with the ATM through the in-vehicle system. This prevents the user from being exposed to the elements while the transaction is occurring.

It is also possible that a user may drive away from the ATM at some point before the transaction is completed 217. If the vehicle leaves the proximity of the ATM (determinable through a number of factors, including loss of NFC, visual camera showing vehicle movement, loss of BT or WiFi connection or other suitable means), the process will cancel or end the current transaction 219. Otherwise, once the transaction is completed 221, the process will naturally end the transaction 223.

FIGS. 3A and 3B show an illustrative validation process. In this illustrative example, secured data is used to validate a user who is attempting to access an account. This particular security process is used for user identification, but does not necessarily relate to the problem of singling out one care amongst a group for initial access.

In this illustrative example, the ATM engages in secured communication with a particular vehicle to allow processing of the transaction 301. Once a connection is established 303, assuming it is established before a timeout occurs 305, the process receives some measure of secured data from the vehicle 307.

FIG. 3B shows some examples of illustrative secured data that may be received. For example, the process may receive an account ID number 321. This number can be input by a user, or, in another example, can be stored locally at the vehicle, having been input when the account was created. A remote record of the account information being stored with respect to the VIN or other vehicle identifier may also be present. For example, if NFC was used to identify the vehicle, the process would want to ensure that the presented account number corresponded to the vehicle which the NFC identified as being present at the ATM.

Also, the process may receive one or more vehicle identifiers. These include VINs or other information usable to compare the vehicle to the account information to ensure that they both belong to the same person or are authorized for use with a certain account. Finally, in this example, the user's PIN number is received 325.

Once sufficient information has been received by the ATm, the process will access a remote account database 309. When one or more accounts was initially linked with the vehicle, the process may have established correspondences with the account information and vehicle information for safety purposes. This information can be accessed by the ATM, and the received information can be compared to the remotely stored information to determine if the user can be verified 311. If the user is a legitimate and authorized user (at least as far as the information indicates) 313, the process proceeds with the transaction 315. Otherwise, the process may exit.

FIG. 4 shows an illustrative example of another transaction process. This process is somewhat more comprehensive than the previously presented processes, but is provided for illustrative purposes only. This process is also representative of a vehicle-side process. In this illustrative example, the process receives a communication request from an ATM machine 401.

Responsive to the received connection request, the process engages in wireless communication with the ATM machine 403. This can include BLUETOOTH or WiFi communication, or any other suitable means of wireless information transfer. In connection with the connection request, the vehicle may also receive an authentication request from the ATM 405. As previously discussed, this can authenticate both the vehicle as the vehicle present at the ATM and authenticate a user account as being usable in conjunction with that vehicle.

Authentication data for the user account may be stored in one of several places. In one example, the account information is stored in the vehicle 407. If this is the case, the process will access the account information stored in the vehicle, and send that data 413 to the requesting ATM. In other instances, the account information may be stored in a phone or other mobile device. If the account information is not stored in the vehicle, the vehicle will connect to the mobile device 409 with the intention of retrieving the information from that device. Once the vehicle has connected to the device, the process checks to see if the account information is stored on the phone 411. If the information is not stored on the phone, the process will exit.

If the information is stored on the phone, the process will pull the requisite data from the phone 415. This information can then be transferred to the requesting ATM in response to the request for account information as part of the authorization request.

Once the ATM has all the requisite data, it will engage in an authentication process. If the user is successfully authenticated 417, the process will engage in processing commands to the ATM. If the user is not authenticated, the process will alert the user to the error 415 and exit, allowing the user to physically interact with the ATM to complete the transaction.

If the user is authenticated, and the processing continues 421, the system will track vehicle movement, in order to terminate a transaction if the user moves beyond a certain distance. If the vehicle movement passes an end transaction threshold 423, the process will alert the user 425 and end the transaction. If the movement is not past the threshold (e.g., the user simply pulls up a bit to better access the ATM), the process will continue until such time as the transaction is complete 427. Once the transaction is complete, the user will obtain a receipt 429 and the process will exit.

FIG. 5 shows an illustrative example of an account setup process. In this illustrative example, the user engages in an account setup process facilitated through the vehicle computing system. The process begins by launching an account setup screen 501. This screen provides input so the user can enter key information, such as user identifying information 503. The user identifying information is received by the process (along with any other identifying information, as desired) and the process associates the user identifying information with a vehicle account 505.

The association is typically done on a remote server, which can also be accessed by the ATM, so that verification at a later date can take place. Once the user has associated the account information with the vehicle, if the vehicle arrives at an ATM at a later point, the ATM can receive both account and vehicle identifying information from the user and can use the received information for comparison against the remotely stored information for identifying the user and the vehicle.

The user account information may also be received by the process 509, and the account information can be encrypted and stored locally on the vehicle, for later transmission to an ATM. The user identifying information can include SSN, address, phone number, name and any other useful information to initially validate the user as owning the account.

Once all information has been received, and the appropriate information has been stored, the process contacts a remote server 513 to upload the information 515. The remote server is provided with the identifying information, the account information, and the vehicle information. The first two sets of information can be used to identify the user as owning the account. Then, the account information and the vehicle information can be stored in conjunction for later validation purposes. Once the user and account information have been validated and stored, the process may receive a confirmation from the remote server 517. At this point, the identifying information and the account information can be saved on the vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
an ATM-related processor configured to:
detect a vehicle approach;
wirelessly connect to a vehicle computing system (VCS);
validate a vehicle as a present-vehicle;
receive account and vehicle identifying information;
validate an account as authorized for a transaction in conjunction with the vehicle; and
provide transaction services to the vehicle over the wireless connection, such that the user can interact with an ATM through use of an in-vehicle display.

2. The system of claim 1, wherein the processor is configured to validate a vehicle as a present-vehicle through the use of near-field communication.

3. The system of claim 1, wherein the processor is configured to validate a vehicle as a present-vehicle through the use of a user PIN entered into an ATM.

4. The system of claim 1, wherein the processor is configured to validate the account through contacting a remote server and comparing the account and vehicle identifying information.

5. The system of claim 1, wherein the transaction services include withdrawals, deposits and balance inquiries.

6. A system comprising:
a processor configured to:
receive a request for identifying information from an ATM;
provide account and vehicle identifying information responsive to the request;
receive confirmation that the account is authorized for a transaction in conjunction with the vehicle;
receive a list of ATM-related services;
present the services on a vehicle display for user interaction and selection; and
transmit user requests input on the display to the ATM for servicing.

7. The system of claim 6, wherein the account identifying information includes an account number.

8. The system of claim 7, wherein the account identifying information is stored on the vehicle.

9. The system of claim 7, wherein the account identifying information is input at the vehicle and subsequently provided to the ATM for each transaction.

10. The system of claim 7, wherein the account identifying information includes a PIN.

11. The system of claim 6, wherein the vehicle identifying information includes a vehicle identification number (VIN).

12. The system of claim 6, wherein the display is a touch-screen display.

13. The system of claim 6, wherein the ATM-related services include withdrawals, deposits and balance inquiries.

14. A computer-implemented method comprising:
receiving a request for identifying information from an ATM;
providing account and vehicle identifying information responsive to the request;
receiving confirmation that the account is authorized for a transaction in conjunction with the vehicle;
receiving a list of ATM-related services;
presenting the services on a vehicle display for user interaction and selection; and
transmitting user requests input on the display to the ATM for servicing.

15. The method of claim 14, wherein the account identifying information includes an account number.

16. The method of claim 15, wherein the account identifying information is stored on the vehicle.

17. The method of claim 15, wherein the account identifying information is input at the vehicle and subsequently provided to the ATM for each transaction.

18. The method of claim 15, wherein the account identifying information includes a PIN.

19. The method of claim 14, wherein the vehicle identifying information includes a vehicle identification number (VIN).

20. The method of claim 14, wherein the ATM-related services include withdrawals, deposits and balance inquiries.
